(19) United States
(12) Patent Application Publication
(10) Pub. No.: US 2026/0340646 A1
(43) Pub. Date: Oct. 29, 2026

(54) INTEGRATION ENABLER FOR INTEGRATING METAVERSE SYSTEM WITH THIRD-PARTY SERVICE SYSTEM AND METHOD OF OPERATING THE SAME

(71) Applicant: Electronics and Telecommunications Research Institute, Daejeon (KR)

(72) Inventors: Changkyu LEE, Daejeon (KR); Seung Yun LEE, Daejeon (KR)

(73) Assignee: Electronics and Telecommunications Research Institute, Daejeon (KR)

(21) Appl. No.: 19/639,519

(22) Filed: Apr. 6, 2026

(30) Foreign Application Priority Data
Apr. 7, 2025 (KR) 10-2025-0044592
Mar. 9, 2026 (KR) 10-2026-0042018

(51) Int. Cl. G06Q 30/01

(52) U.S. Cl. CPC G06Q 30/01

(57) ABSTRACT

An integration enabler for integrating a metaverse system with a third-party service system and a method of operating the same are provided. The provided method includes receiving, from a metaverse system, a service discovery request to discover third-party services provided by third-party service systems and satisfying defined criteria, in response to the service discovery request, providing a list of the third-party services satisfying the defined criteria to the metaverse system, providing a third-party service selected from the list of the third-party services by a user of the metaverse system to the metaverse system, in response to the user accessing the selected third-party service through the metaverse system, exchanging service data for a third-party service system providing the selected third-party service with the metaverse system, and providing the selected third-party service to the user from the third-party service system.

### CROSS-REFERENCE TO RELATED APPLICATIONS

This application claims the benefit of Korean Patent Application No. 10-2025-0044592, filed on Apr. 7, 2025, and Korean Patent Application No. 10-2026-0042018, filed on Mar. 9, 2026, in the Korean Intellectual Property Office (now the Ministry of Intellectual Property (MOIP)), the entire disclosures of which are incorporated herein by reference for all purposes.

### BACKGROUND

### 1. Field of the Invention

One or more embodiments relate to an integration enabler for integrating a metaverse system with a third-party service system and a method of operating the same.

### 2. DESCRIPTION OF THE RELATED ART

A digital twin is a technology that creates a twin of a real-world object on a computer and simulates situations that may occur in the real world by the computer to predict a result in advance. The digital twin is attracting attention as a technology that may solve various industrial and social problems, not just manufacturing problems.

The digital twin is essentially a combination of information and data representing structures, contexts, and operations of various physical systems, and may be referred to as an interface that may understand past and present operating states and predict the future. The digital twin is a powerful digital entity that may be used to optimize the physical world, and may improve operational performance and business processes.

The above description is information the inventor(s) acquired during the course of conceiving the present disclosure, or already possessed at the time, and is not necessarily art publicly known before the present application was filed.

### SUMMARY

Embodiments provide integrating a physical world and a virtual world using a digital twin.

Embodiments provide integrating a metaverse system with a third-party service system.

Embodiments provide interacting with a third-party service system to provide a third-party services provided by the third-party service system to a user of a metaverse system.

Embodiments provide discovering third-party services provided by a registered third-party service system and satisfying defined criteria in response to a request of a user of a metaverse system, and providing a list of discovered third-party services to the user.

However, the technical aspects are not limited to the aspects described above, and there may be other technical aspects.

According to an aspect, there is provided a method of operating an integration enabler, the method including receiving, from a metaverse system, a service discovery request to discover third-party services provided by third-party service systems and satisfying defined criteria, in response to the service discovery request, providing a list of the third-party services satisfying the defined criteria to the metaverse system, providing a third-party service selected from the list of the third-party services by a user of the metaverse system to the metaverse system, in response to the user accessing the selected third-party service through the metaverse system, exchanging service data for a third-party service system providing the selected third-party service with the metaverse system, and providing the selected third-party service to the user from the third-party service system.

The method may further include receiving system information of the third-party service system from the third-party service system, in response to receiving the system information, registering and storing the system information, and returning a registration result of the system information to the third-party service system.

The method may further include determining whether the third-party services are discontinued or unavailable, and performing deregistration of third-party services that are discontinued or unavailable among the third-party services.

The exchanging of the service data may include performing protocol adaptation for the service data, and exchanging service data adapted according to the protocol adaptation with the third-party service system.

The exchanging of the service data may include performing message formatting to ensure structural compatibility and syntactic compatibility for the service data.

The defined criteria may be determined based on at least one of categories, keywords, and compatibility with the metaverse system for the third-party services.

The providing of the list of the third-party services to the metaverse system may include, in response to the service discovery request, discovering metadata for third-party services including service-level properties, and discovering the list of the third-party services based on the metadata.

According to an aspect, there is provided a method of operating a metaverse system, the method including transmitting, to an integration enabler, a service discovery request to discover third-party services provided by third-party service systems and satisfying defined criteria, in response to the service discovery request, receiving a list of the third-party services satisfying the defined criteria from the metaverse system, transmitting information for accessing a third-party service selected from the list of the third-party services by a user of the metaverse system to a third-party service system providing the selected third-party service through the integration enabler, and in response to the user accessing the selected third-party service through the metaverse system, exchanging service data for the third-party service system with the integration enabler.

Protocol adaptation may be performed by the integration enabler, and the service data may be adapted according to the protocol adaptation and exchanged with the third-party service system.

Message formatting may be performed to ensure structural compatibility and syntactic compatibility for the service data, and the service data may be exchanged with the third-party service system.

The defined criteria may be determined based on at least one of categories, keywords, and compatibility with the metaverse system for the third-party services.

The receiving of the list of the third-party services from the metaverse system may include, in response to the service discovery request, receiving the list of the third-party services discovered based on metadata for third-party services including service-level properties.

According to an aspect, there is provided an integration enabler includes a processor, and memory storing instructions. The instructions, when executed by the processor, cause the integration enabler to receive, from a metaverse system, a service discovery request to discover third-party services provided by third-party service systems and satisfying defined criteria, in response to the service discovery request, provide a list of the third-party services satisfying the defined criteria to the metaverse system, provide a third-party service selected from the list of the third-party services by a user of the metaverse system to the metaverse system, in response to the user accessing the selected third-party service through the metaverse system, exchange service data for a third-party service system providing the selected third-party service with the metaverse system, and provide the selected third-party service to the user from the third-party service system.

The instructions, when executed by the processor, may cause the integration enabler to receive system information of the third-party service system from the third-party service system, in response to receiving the system information, register and store the system information, and return a registration result of the system information to the third-party service system.

The instructions, when executed by the processor, may cause the integration enabler to determine whether the third-party services are discontinued or unavailable, and perform deregistration of third-party services that are discontinued or unavailable among the third-party services.

The instructions, when executed by the processor, may cause the integration enabler to perform protocol adaptation for the service data, and exchange service data adapted according to the protocol adaptation with the third-party service system.

The instructions, when executed by the processor, may cause the integration enabler to perform message formatting to ensure structural compatibility and syntactic compatibility for the service data.

The defined criteria may be determined based on at least one of categories, keywords, and compatibility with the metaverse system for the third-party services.

The instructions, when executed by the processor, may cause the integration enabler to, in response to the service discovery request, discover metadata for third-party services including service-level properties, and discover the list of the third-party services based on the metadata.

Additional aspects of embodiments will be set forth in part in the description which follows and, in part, will be apparent from the description, or may be learned by practice of the disclosure.

According to embodiments, integrating a physical world and a virtual world through a digital twin may provide a user with a more realistic metaverse.

According to embodiments, integrating a metaverse system and a third-party service system may provide a user of the metaverse system with various third-party services.

According to embodiments, protocol adaption and/or message formatting may improve interoperability and compatibility between a metaverse system and third-party service systems.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an integration enabler according to an embodiment;

FIG. 2 is a diagram illustrating functions of a metaverse system according to an embodiment;

FIG. 3 is a diagram illustrating functions of a third-party service system according to an embodiment;

FIG. 4 is a diagram illustrating functions of an integration enabler according to an embodiment;

FIG. 5 is a diagram illustrating interfaces and reference points between an integration enabler, a metaverse system, and a third-party service system according to an embodiment;

FIG. 6 is a diagram illustrating an operation flow of an integration enabler for integrating a third-party service system and a metaverse system according to an embodiment;

FIG. 7 is a flowchart illustrating a method of operating an integration enabler according to an embodiment;

FIG. 8 is a flowchart illustrating a method of operating a metaverse system according to an embodiment;

FIG. 9 is a block diagram illustrating an integration enabler according to an embodiment; and

FIG. 10 is a block diagram illustrating a metaverse system according to an embodiment.

### DETAILED DESCRIPTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Although terms of "first," "second," and the like are used to explain various components, the components are not limited to such terms. These terms are used only to distinguish one component from another component. For example, a first component may be referred to as a second component, or similarly, the second component may be referred to as the first component.

It should be noted that if one component is described as being "connected", "coupled", or "joined" to another component, a third component may be "connected", "coupled", and "joined" between the first and second components, although the first component may be directly connected, coupled, or joined to the second component.

As used herein, the singular forms "a," "an," and "the" are intended to include the plural forms as well, unless the context clearly indicates otherwise. As used herein, "A or B," "at least one of A and B," "at least one of A or B," "A, B or C," "at least one of A, B and C," and "at least one of A, B, or C," each of which may include any one of the items listed together in the corresponding one of the phrases, or all possible combinations thereof. It will be further understood that the terms "comprises" and/or "comprising," when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

The term "unit" or the like used herein may refer to a software or hardware component, such as a field-programmable gate array (FPGA) or an ASIC, and the "unit" performs predefined functions. However, the term "unit" is not limited to software or hardware. A "unit" may be configured to be in an addressable storage medium or configured to operate one or more processors. Accordingly, the "unit" may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and "units" may be combined into fewer components and "units" or may be further separated into additional components and "units." Furthermore, the components and "units" may be implemented to operate on one or more central processing units (CPUs) within a device or a security multimedia card. In addition, "unit" may include one or more processors.

Hereinafter, embodiments will be described in detail with reference to the accompanying drawings. When describing the embodiments with reference to the accompanying drawings, like reference numerals refer to like components and a repeated description related thereto will be omitted.

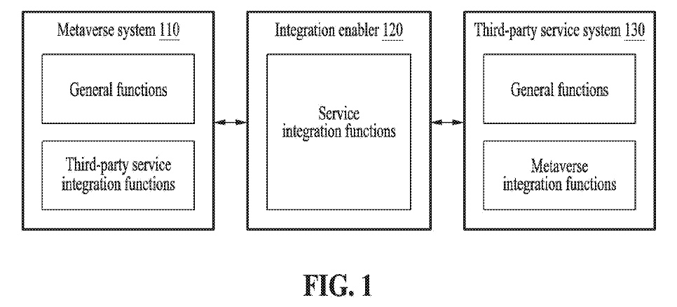

FIG. 1 is a diagram illustrating an integration enabler according to an embodiment.

Referring to FIG. 1, an integration enabler 120 may integrate a metaverse system 110 and a third-party service system 130 through a digital twin, thereby integrating a virtual world and a physical world. In addition, the integration enabler 120 may integrate the metaverse system 110 with a digital twin system (not shown) while integrating the metaverse system 110 and the third-party service system 130.

A physical object may refer to an object that exists in the physical world. For example, the physical object may refer to an object having a distinct existence in the physical world, whether tangible (e.g., a machine or a device) or intangible (e.g., a process or a traffic flow). In the disclosure, for convenience of description, the physical object may also be referred to as an actual object or a real-world object.

A virtual object may refer to a computer-generated entity designated for the virtual world. The virtual object may be a replica associated with a physical object and may serve as a digital twin.

The physical world may refer to a spatial organization of a plurality of physical objects. In the disclosure, for convenience of description, the physical world may also be referred to as the actual world or the real world.

The virtual world may refer to a spatial organization of a plurality of virtual objects. The virtual world may include global behavior. In the virtual world, users may generate avatars representing themselves and may interact with virtual objects and other avatars in various ways.

A metaverse may refer to a collective virtual environment in which the physical world and the virtual world are converged to allow a user to interact with shared digital spaces, objects, and services. The metaverse may be virtual, may be augmented, may represent the real world, or may be associated with the real world. In other words, the metaverse may include virtual reality (VR), augmented reality (AR), and mixed reality (MR). The metaverse may be an integrated ecosystem of virtual worlds that provides a user with an immersive experience and may modify existing elements from economic, environmental, social, or cultural perspectives and generate new values. The metaverse may include virtual worlds implemented to enable human activities of the real world.

A digital twin may refer to a digital representation of an object of interest. For example, the digital twin may refer to a digital representation that implements physical objects of the physical world in a virtual world or a metaverse. The digital twin may require different functions (e.g., synchronization or real-time support) depending on application fields. The digital twin may serve to associate the virtual world with the physical world and may enable a user to extend experience beyond the limitations of a virtual environment. As a digital representation of physical objects, the digital twin may be part of the virtual world. For example, an avatar that represents a user may be a digital twin in the virtual world. The digital twin may function as an entity that operates between the two worlds to associate the virtual world with the physical world. For example, a digital twin of a user may be implemented as an avatar and may reflect facial expressions captured by user equipment.

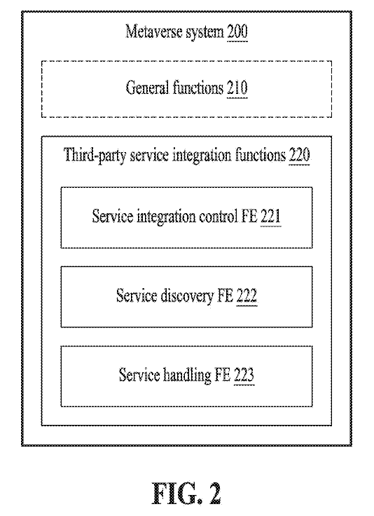

The metaverse system 110 may implement a metaverse service by designing and providing a virtual world customized based on user preferences. The metaverse system 110 may provide general functions (GFs) and third-party service integration functions (TSIFs). Here, for convenience of description, the TSIFs may also be referred to as service integration functions (SIFs). The TSIFs provided by the metaverse system 110 are described in detail below with reference to FIG. 2.

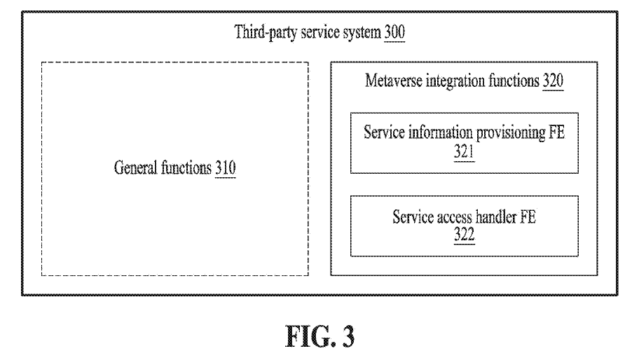

The third-party service system 130 may provide external services such as payment processing, logistics, or online shopping and may integrate these services into a metaverse to enhance functions and provide a user with a richer and more interactive experience. In the disclosure, for convenience of description, an external service provided by the third-party service system 130 may also be referred to as a third-party service. The third-party service system 130 may provide GFs and metaverse integration functions (MIFs). The MIFs provided by the third-party service system 130 are described in detail below with reference to FIG. 3.

The integration enabler 120, as illustrated in FIG. 1, may be a standalone system, but may alternatively be included in the metaverse system 110 or the third-party service system 130 according to embodiments. For example, the integration enabler 120 may be implemented as a set of functions existing in the metaverse system 110 and/or the third-party service system 130. For instance, the integration enabler 120 may be implemented by a processor included in the metaverse system 110 or the third-party service system 130.

In an embodiment, the metaverse system 110, the integration enabler 120, and the third-party service system 130 may each be implemented as an electronic device including a processor and a memory.

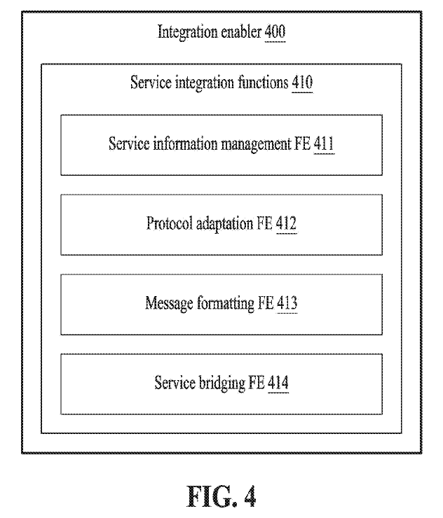

According to an embodiment, the integration enabler 120 may serve as a core management framework that enables seamless integration between the metaverse system 110 and the third-party service system 130. The integration enabler 120 may provide a function for interacting with a digital twin system such that a physical object may be used as a virtual object in a metaverse. The integration enabler 120 may support interoperability with the third-party service system 130, thereby enabling services provided by the third-party service system 130 to be seamlessly integrated into the virtual world. The integration enabler 120 may include various SIFs. The SIFs provided by the integration enabler 120 are described in detail below with reference to FIG. 4.

FIG. 2 is a diagram illustrating functions of a metaverse system according to an embodiment.

Referring to FIG. 2, a metaverse system 200 may provide GFs 210 and TSIFs 220. The TSIFs 220 illustrated in FIG. 2 are only examples for description, and embodiments are not limited thereto. For example, the metaverse system 200 may be implemented by excluding some of the physical TSIFs 220 illustrated in FIG. 2 or by adding other functions.

The GFs 210 may be functions required for the metaverse system 200 to provide a standalone service. The GFs 210 may include one or more functions for integrating a digital twin, which is a virtual object, with a corresponding physical object. The TSIFs 220 may support integration with a third-party service system.

In the disclosure, a functional entity (FE) may refer to a functional element for achieving a particular operational purpose. For example, an FE may refer to a function that is not further subdivided. The GFs 210 illustrated in FIG. 2 and the operations represented by the FEs illustrated therein may be performed by at least one component (e.g., a processor) of the metaverse system 200.

A service integration control FE (SIC-FE) 221 may provide a function for determining whether interaction with external third-party service systems is required in response to a user request in the metaverse system 200. The SIC-FE 221 may coordinate a service flow that includes service discovery, authentication, and session invocation. In addition, the SIC-FE 221 may interact with the GFs 210 of the metaverse system 200 to initiate or manage services related to external integration.

A service discovery FE (SD-FE) 222 may provide a function for discovering metadata of available third-party services by interacting with an integration enabler under the control of the SIC-FE 221. The SD-FE 222 may enable the metaverse system 200 to identify services that satisfy user request criteria. The identified services may be transmitted to the SIC-FE 221 to support decision making on service invocation.

A service handling FE (SH-FE) 223 may provide a function for managing an actual interaction session between the metaverse system 200 and a third-party service system. The SH-FE 223 may handle service invocation, data exchange, and session lifecycle management through the integration enabler. The SH-FE 223 may operate under the guidance of the SIC-FE 221 to ensure that user experience is maintained consistently and safely during external service execution.

FIG. 3 is a diagram illustrating functions of a third-party service system according to an embodiment.

Referring to FIG. 3, a third-party service system 300 may provide GFs 310 and MIFs 320. The MIFs 320 illustrated in FIG. 3 are only examples for description, and embodiments are not limited thereto. For example, the third-party service system 300 may be implemented by excluding some of the MIFs 320 illustrated in FIG. 3 or by adding other functions.

The GFs 310 may be functions required for the third-party service system 300 to provide a standalone service. The GFs 310 may include one or more functions for integrating a third-party service with a metaverse. The MIFs 320 may support integration with a metaverse system.

A service information provisioning FE (SIP-FE) 321 may provide a function for providing and managing metadata of services offered by the third-party service system 300. The SIP-FE 321 may obtain service information from the GFs 310 and may register or update the metadata with a SIM-FE of an integration enabler. The SIP-FE 321 may enable the metaverse system to discover the services.

A service access handler FE (SAH-FE) 322 may provide a function for receiving service-related requests and authentication-related requests from the integration enabler. The SAH-FE 322 may serve as a single-entry point for external integrations and may forward the requests to appropriate internal components of the third-party service system 300. In addition, the SAH-FE 322 may mediate communication with internal systems, such as support mappers or the GFs 310, depending on the type and purpose of the request.

FIG. 4 is a diagram illustrating functions of an integration enabler according to an embodiment.

Referring to FIG. 4, an integration enabler 400 may provide SIFs 410. The SIFs 410 illustrated in FIG. 4 are only examples for description, and embodiments are not limited thereto. For example, the integration enabler 400 may be implemented by excluding some of the SIFs 410 illustrated in FIG. 4 or by adding other functions. In an embodiment, the SIFs 410 may support integration between a metaverse system and a third-party service system.

The operations represented by the FEs illustrated in FIG. 4 may be performed by at least one component (e.g., a processor) of the integration enabler 400.

A SIM-FE 411 may provide a function for storing, managing, and providing metadata of third-party services. The SIM-FE 411 may support registration of service information of third-party service systems and may transmit the associated service metadata to the metaverse system through an SD-FE of the metaverse system. In addition, the SIM-FE 411 may serve as a registry and discovery backend that supports dynamic service interactions.

The PA-FE 412 may provide a function for converting communication protocols, encoding schemes, or interface structures between the metaverse system and third-party service systems. The PA-FE 412 may adapt protocol-level differences to support seamless interoperability between heterogeneous systems. In addition, the PA-FE 412 may operate as a support component that is invoked when a service bridging FE (SB-FE) 414 is required.

A message formatting FE (MF-FE) 413 may provide a function for formatting request messages and response messages to ensure structural compatibility and syntactic compatibility between the metaverse system and third-party services. The MF-FE 413 may be used by the SB-FE 414 whenever message-level conversion is required.

The SB-FE 414 may provide a function for bridging service requests from the metaverse system to a third-party service system. The SB-FE 414 may coordinate the flow of service invocation and may invoke the PA-FE 412 and the MF-FE 413 as needed to ensure appropriate communication. In addition, the SB-FE 414 may serve as a central bridging point between the systems.

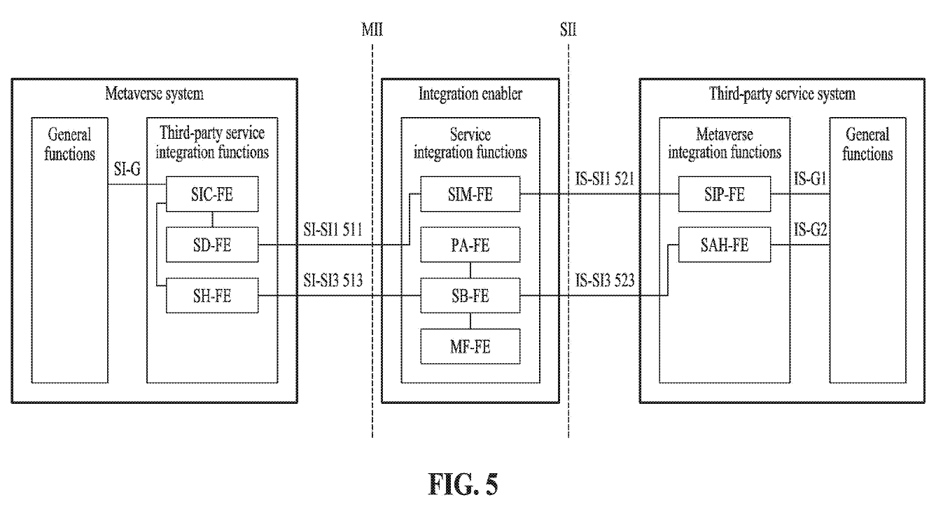

FIG. 5 is a diagram illustrating interfaces and reference points between an integration enabler, a metaverse system, and a third-party service system according to an embodiment.

Referring to FIG. 5, a metaverse integration interface (MII) indicating an interface between the integration enabler and the metaverse system, and a service integration interface (SII) indicating an interface between the integration enabler and the third-party service system are illustrated as an example. The MII and the SII may include various reference points that support interactions among associated FEs.

The MII may enable interaction between the integration enabler and the metaverse system. In addition, the MII may be used for the following tasks:
discovering available digital twin systems within the metaverse system;
discovering metadata of available digital twin models;
exchanging data required to use and register digital twins; and
exchanging synchronization-related data between digital twins and corresponding physical objects.

The SII may enable interaction between the integration enabler and the third-party service system. In addition, the SII may be used for the following tasks: -
registering and managing third-party service information;
authenticating users for selected third-party services; and
exchanging service-related data between the third-party service system and the metaverse system.

The DII may enable interaction between the integration enabler and the digital twin system. In addition, the DII may be used for the following tasks:
registering digital twin system information;
registering digital twin model metadata;
exchanging data required to use and register digital twins; and
exchanging synchronization-related data between digital twins and corresponding physical objects.

A service integration-service integration 1 (SI-SI1) 511 may indicate a reference point between an SD-FE of the metaverse system and a SIM-FE of the integration enabler. The SI-SI1 511 may be used to discover available third-party services within the metaverse.

The metaverse system may request information regarding available types of third-party services from the integration enabler through the SI-SI1 511. The integration enabler may then provide information regarding third-party services registered with the integration enabler.

The SI-SI1 511 may support the following tasks:
initiating a service discovery request from an SD-FE to a SIM-FE, including optional filters such as categories, keywords, and compatibility criteria (e.g., service or data format versions);
discovering metadata of particular third-party services, including technical, operational, and service-level properties;
obtaining a categorized or hierarchical list of third-party service types to assist service catalog navigation; and
discovering the operational state of each service item, such as active, deprecated, or under maintenance, to support runtime decision-making.

An SI-SI3 513 may indicate a reference point between an SH-FE of the metaverse system and an SB-FE of the integration enabler. The SI-SI3 513 may be used to support the exchange of data required to use third-party services within the metaverse environment. The SB-FE may enhance compatibility between the associated systems by performing protocol adaptation, data format conversion, or other interworking functions as part of its bridging role.

The SI-SI3 513 may support the following tasks:
transmitting input data from the metaverse system to the third-party service system; and
receiving output data generated by the third-party service and forwarding it to the metaverse system.

Referring to FIG. 5, SI-G (service integration general function) may indicate a reference point between a SIC-FE of the metaverse system and GFs of the metaverse system.

An integration support-service integration 1 (IS-SI1) 521 may indicate a reference point between a SIP-FE of the third-party service system and a SIM-FE of the integration enabler. The IS-SI1 521 may be used to support registration and discovery of information regarding third-party service systems that provide services intended to be used in the metaverse environment.

The third-party service system may register service-related information, including metadata and operational descriptors, through the IS-SI1 521. The IS-SI1 521 may support discovery and management of previously registered service information.

The IS-SI1 521 may support the following tasks:
registering third-party service system information, including system name, service type, provider organization, and supported interfaces;
updating or modifying previously registered information to reflect changes in service configuration or operational state; and
deregistering third-party service systems when services are discontinued or unavailable.

An IS-SI3 523 may indicate a reference point between an SAH-FE of the third-party service system and an SB-FE of the integration enabler. The IS-SI3 523 may be used to support the exchange of input and output data associated with third-party service execution triggered by the metaverse system.

The third-party service system may receive input data for service handling through the IS-SI3 523 and may return the service data as output. The SB-FE may perform protocol intermediation or data format adaptation to ensure interoperability between systems when the metaverse system and the third-party service system use heterogeneous communication mechanisms or data schemas.

The IS-SI3 523 may support the following tasks:
receiving input data (including user requests, parameters, or contextual information required to execute a third-party service) from an SB-FE to an SAH-FE; and
transmitting output data (including response results, generated content, or values computed based on third-party service logic) from an SAH-FE to an SB-FE.

Referring to FIG. 5, IS-G1 (integration support general function) may indicate a reference point between an SIP-FE of the third-party service system and GFs of the third-party service system. In addition, IS-G2 may indicate a reference point between an SAH-FE of the third-party service system and the GFs of the third-party service system.

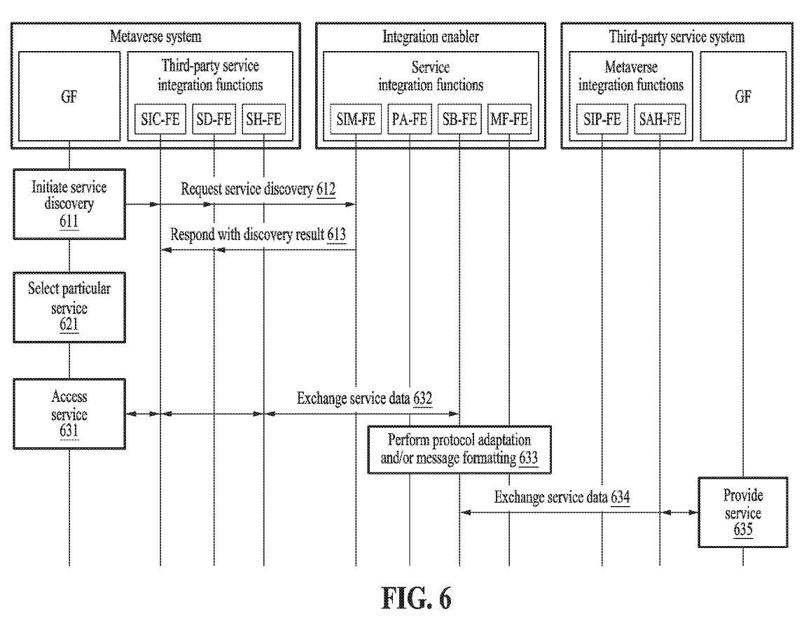

FIG. 6 is a diagram illustrating an operation flow of an integration enabler for integrating a third-party service system and a metaverse system according to an embodiment.

Referring to FIG. 6, an operation flow in which the integration enabler integrates third-party services into the metaverse system is illustrated as an example. In FIG. 6, for ease of description, each operation is illustrated and described as being performed by corresponding FEs, but, according to embodiments, the operations may be performed by an apparatus or a system (e.g., the metaverse system, the integration enabler, or the third-party service system) including the corresponding FEs.

Hereinafter, operations may be performed sequentially but not necessarily. For example, the order of the operations may change, and at least two of the operations may be performed in parallel. Operations 611 to 635 may each be performed by at least one component (e.g., a processor) of the metaverse system, the integration enabler, or the third-party service system.

In operation 611, the metaverse system may discover third-party service systems that satisfy specified criteria and may initiate a service discovery request through its SIC-FE and SD-FE.

In operation 612, the SD-FE of the metaverse system may transmit the service discovery request to the SIM-FE of the integration enabler.

In operation 613, the SIM-FE of the integration enabler may provide, as a response, a list of available third-party services that match the discovery criteria, and the metaverse system may receive the discovery result. For example, the discovery criteria may correspond to criteria requested by the metaverse system.

In operation 621, a user may select a particular service. In addition, the metaverse system may start an authentication process for accessing a third-party service selected by the user.

In operation 631, the user may access the selected third-party service through the metaverse system. In an embodiment, upon successful authentication based on an authentication process, the user may access a selected third-party service through the metaverse system.

In operation 632, an SH-FE of the metaverse system may exchange service data with an SB-FE of the integration enabler.

In operation 633, the SB-FE of the integration enabler may perform selective protocol adaptation and/or message formatting.

In operation 634, the SB-FE of the integration enabler may exchange the adapted service data with the SAH-FE of the third-party service system.

In operation 635, the third-party service system may provide the selected service to the user.

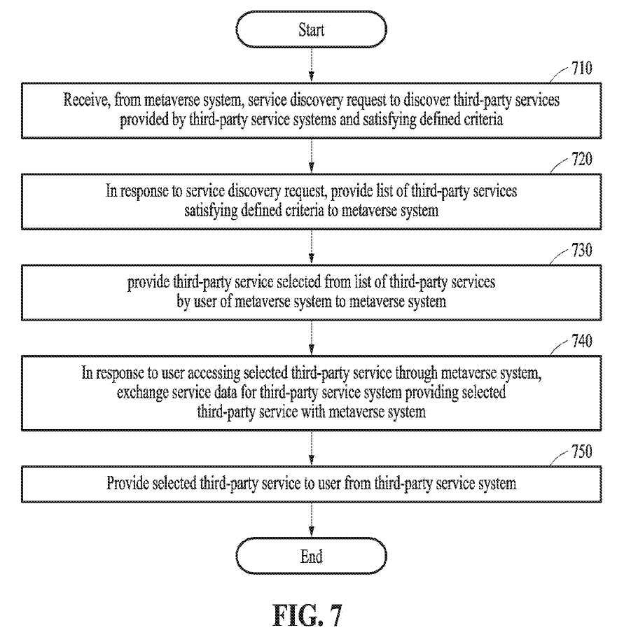

FIG. 7 is a flowchart illustrating a method of operating an integration enabler according to an embodiment.

Hereinafter, operations may be performed sequentially but not necessarily. For example, the order of the operations may change, and at least two of the operations may be performed in parallel. Operations 710 to 750 may be performed by at least one component (e.g., a processor) of the integration enabler.

The integration enabler may receive system information of the third-party service system from the third-party service system. The integration enabler may register and store the system information in response to receiving the system information. The integration enabler may return a registration result of the system information to the third-party service system. The integration enabler may determine whether third-party services are discontinued or unavailable. The integration enabler may perform deregistration of third-party services that are discontinued or unavailable among the third-party services.

In operation 710, the integration enabler may receive, from a metaverse system, a service discovery request to discover third-party services provided by third-party service systems and satisfying defined criteria. The defined criteria may be determined based on at least one of categories, keywords, and compatibility with the metaverse system for the third-party services.

In operation 720, in response to the service discovery request, the integration enabler may provide a list of the third-party services satisfying the defined criteria to the metaverse system. In response to the service discovery request, the integration enabler may discover metadata for third-party services including service-level properties, and discover the list of the third-party services based on the metadata.

In operation 730, the integration enabler may provide a third-party service selected from the list of the third-party services by a user of the metaverse system to the metaverse system.

In operation 740, in response to the user accessing the selected third-party service through the metaverse system, the integration enabler may exchange service data for a third-party service system providing the selected third-party service with the metaverse system. The integration enabler may perform protocol adaptation for the service data, and exchange service data adapted according to the protocol adaptation with the third-party service system. The integration enabler may perform message formatting to ensure structural compatibility and syntactic compatibility for the service data.

In operation 750, the integration enabler may provide the selected third-party service to the user from the third-party service system.

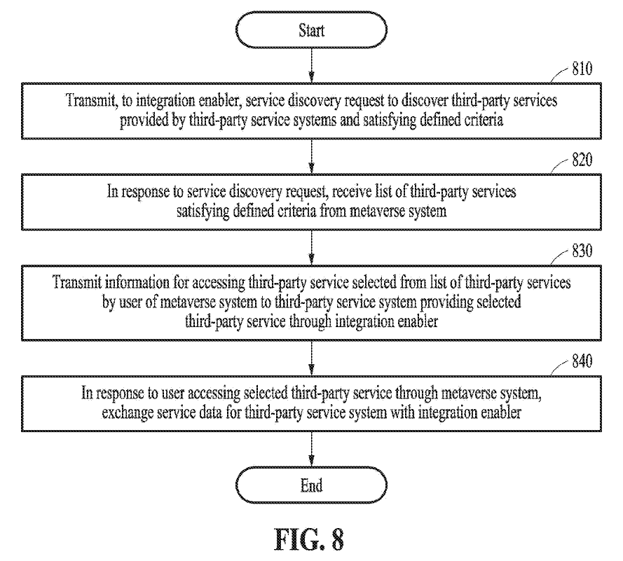

FIG. 8 is a flowchart illustrating a method of operating a metaverse system according to an embodiment.

Hereinafter, operations may be performed sequentially but not necessarily. For example, the order of the operations may change, and at least two of the operations may be performed in parallel. Operations 810 to 840 may be performed by at least one component (e.g., a processor, etc.) of the metaverse system.

In operation 810, the metaverse system may transmit, to an integration enabler, a service discovery request to discover third-party services provided by third-party service systems and satisfying defined criteria. The defined criteria may be determined based on at least one of categories, keywords, and compatibility with the metaverse system for the third-party services.

In operation 820, in response to the service discovery request, the metaverse system may receive a list of the third-party services satisfying the defined criteria from the metaverse system. In response to the service discovery request, the metaverse system may receive the list of the third-party services discovered based on metadata for third-party services including service-level properties.

In operation 830, the metaverse system may transmit information for accessing a third-party service selected from the list of the third-party services by a user of the metaverse system to a third-party service system providing the selected third-party service through the integration enabler.

In operation 840, in response to the user accessing the selected third-party service through the metaverse system, the metaverse system may exchange service data for the third-party service system with the integration enabler. Protocol adaptation may be performed by the integration enabler, and the service data may be adapted according to the protocol adaptation and exchanged with the third-party service system. Message formatting may be performed to ensure structural compatibility and syntactic compatibility for the service data, and the service data may be exchanged with the third-party service system.

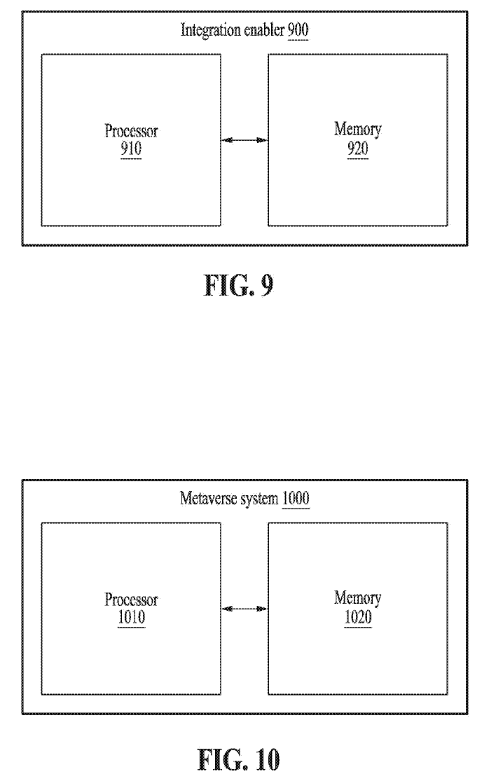

FIG. 9 is a block diagram illustrating an integration enabler according to an embodiment.

Referring to FIG. 9, an integration enabler 900 may include a processor 910. The processor 910 may include at least one processor. In addition, the integration enabler 900 may further include memory 920.

The memory 920 may store instructions (e.g., programs) executable by the processor 910. For example, the instructions may include instructions for performing the operation of the processor 910 and/or the operation of each component of the processor 910.

The processor 910 may be a device for executing instructions or programs or controlling the integration enabler 900, and may include, for example, various processors, such as a CPU or a graphics processing unit (GPU). The processor 910 may receive, from a metaverse system, a service discovery request to discover third-party services provided by third-party service systems and satisfying defined criteria. In response to the service discovery request, the processor 910 may provide a list of the third-party services satisfying the defined criteria to the metaverse system. The processor 910 may provide a third-party service selected from the list of the third-party services by a user of the metaverse system to the metaverse system. In response to the user accessing the selected third-party service through the metaverse system, the processor 910 may exchange service data for a third-party service system providing the selected third-party service with the metaverse system. The processor 910 may provide the selected third-party service to the user from the third-party service system.

The processor 910 may receive system information of the third-party service system from the third-party service system, in response to receiving the system information, register and store the system information, and return a registration result of the system information to the third-party service system. The processor 910 may determine whether the third-party services are discontinued or unavailable, and perform deregistration of third-party services that are discontinued or unavailable among the third-party services. The processor 910 may perform protocol adaptation for the service data, and exchange service data adapted according to the protocol adaptation with the third-party service system. The processor 910 may perform message formatting to ensure structural compatibility and syntactic compatibility for the service data. The defined criteria may be determined based on at least one of categories, keywords, and compatibility with the metaverse system for the third-party services. In response to the service discovery request, the processor 910 may discover metadata for third-party services including service-level properties, and discover the list of the third-party services based on the metadata.

FIG. 10 illustrates an example of a metaverse system according to an embodiment.

Referring to FIG. 10, a metaverse system 1000 may include a processor 1010. The processor 1010 may include at least one processor. Additionally, the metaverse system 1000 may further include memory 1020.

The memory 1020 may store instructions (e.g., programs) executable by the processor 1010. For example, the instructions may include instructions for performing the operation of the processor 1010 and/or the operation of each component of the processor 1010.

The processor 1010 may be a device that executes instructions or programs, or controls the metaverse system 1000, and may include, for example, various processors such as a central processing unit (CPU) and a graphics processing unit (GPU). The processor 1010 may transmit, to an integration enabler, a service discovery request to discover third-party services provided by third-party service systems and satisfying defined criteria. In response to the service discovery request, the processor 1010 may receive a list of the third-party services satisfying the defined criteria from the metaverse system. The processor 1010 may transmit information for accessing a third-party service selected from the list of the third-party services by a user of the metaverse system to a third-party service system providing the selected third-party service through the integration enabler. In response to the user accessing the selected third-party service through the metaverse system, the processor 1010 may exchange service data for the third-party service system with the integration enabler.

Protocol adaptation may be performed by the integration enabler, and the service data may be adapted according to the protocol adaptation and exchanged with the third-party service system. Message formatting may be performed to ensure structural compatibility and syntactic compatibility for the service data, and the service data may be exchanged with the third-party service system. The defined criteria may be determined based on at least one of categories, keywords, and compatibility with the metaverse system for the third-party services. In response to the service discovery request, the processor 1010 may receive the list of the third-party services discovered based on metadata for third-party services including service-level properties.

The embodiments described herein may be implemented using hardware components, software components, or a combination thereof. For example, the device, the method, and the components described in the embodiments may be implemented using a general-purpose or special-purpose computer, such as a processor, a controller and an arithmetic logic unit (ALU), a digital signal processor (DSP), a microcomputer, a FPGA, a programmable logic unit (PLU), a microprocessor, or any other devices capable of responding to and executing instructions. A processing device may run an operating system (OS) and a software application that runs on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors or a single processor and a single controller. In addition, different processing configurations are possible, such as parallel processors.

Software may include a computer program, a piece of code, an instruction, or one or more combinations thereof, to independently or collectively instruct or configure a processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in non-transitory computer-readable storage media.

The method according to the above-described embodiments may be recorded in non-transitory computer-readable media including program instructions to implement various operations which may be performed by a computer. The non-transitory computer-readable storage media may also store, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable storage media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and equivalents to the claims are also within the scope of the following claims.

What is claimed is:

1. A method of operating an integration enabler, the method comprising:
receiving, from a metaverse system, a service discovery request to discover third-party services provided by third-party service systems and satisfying defined criteria;
in response to the service discovery request, providing a list of the third-party services satisfying the defined criteria to the metaverse system;
providing a third-party service selected from the list of the third-party services by a user of the metaverse system to the metaverse system;
in response to the user accessing the selected third-party service through the metaverse system, exchanging service data for a third-party service system providing the selected third-party service with the metaverse system; and
providing the selected third-party service to the user from the third-party service system.

2. The method of claim 1, further comprising:
receiving system information of the third-party service system from the third-party service system;
in response to receiving the system information, registering and storing the system information; and
returning a registration result of the system information to the third-party service system.

3. The method of claim 2, further comprising:
determining whether the third-party services are discontinued or unavailable; and
performing deregistration of third-party services that are discontinued or unavailable among the third-party services.

4. The method of claim 1, wherein the exchanging of the service data comprises:
performing protocol adaptation for the service data; and
exchanging service data adapted according to the protocol adaptation with the third-party service system.

5. The method of claim 1, wherein the exchanging of the service data comprises performing message formatting to ensure structural compatibility and syntactic compatibility for the service data.

6. The method of claim 1, wherein the defined criteria are determined based on at least one of categories, keywords, and compatibility with the metaverse system for the third-party services.

7. The method of claim 1, wherein the providing of the list of the third-party services to the metaverse system comprises:
in response to the service discovery request, discovering metadata for third-party services comprising service-level properties; and
discovering the list of the third-party services based on the metadata.

8. A method of operating a metaverse system, the method comprising:
transmitting, to an integration enabler, a service discovery request to discover third-party services provided by third-party service systems and satisfying defined criteria;
in response to the service discovery request, receiving a list of the third-party services satisfying the defined criteria from the metaverse system;
transmitting information for accessing a third-party service selected from the list of the third-party services by a user of the metaverse system to a third-party service system providing the selected third-party service through the integration enabler; and
in response to the user accessing the selected third-party service through the metaverse system, exchanging service data for the third-party service system with the integration enabler.

9. The method of claim 8, wherein protocol adaptation is performed by the integration enabler, and the service data is adapted according to the protocol adaptation and exchanged with the third-party service system.

10. The method of claim 8, wherein message formatting is performed to ensure structural compatibility and syntactic compatibility for the service data, and the service data is exchanged with the third-party service system.

11. The method of claim 8, wherein the defined criteria are determined based on at least one of categories, keywords, and compatibility with the metaverse system for the third-party services.

12. The method of claim 8, wherein the receiving of the list of the third-party services from the metaverse system comprises, in response to the service discovery request, receiving the list of the third-party services discovered based on metadata for third-party services comprising service-level properties.

13. A non-transitory computer-readable storage medium storing instructions that, when executed by a processor, cause the processor to perform the method of claim 1.

14. An integration enabler comprising:
a processor; and
memory storing instructions,
wherein the instructions, when executed by the processor, cause the integration enabler to:
receive, from a metaverse system, a service discovery request to discover third-party services provided by third-party service systems and satisfying defined criteria;
in response to the service discovery request, provide a list of the third-party services satisfying the defined criteria to the metaverse system;
provide a third-party service selected from the list of the third-party services by a user of the metaverse system to the metaverse system;
in response to the user accessing the selected third-party service through the metaverse system, exchange service data for a third-party service system providing the selected third-party service with the metaverse system; and
provide the selected third-party service to the user from the third-party service system.

15. The integration enabler of claim 14, wherein the instructions, when executed by the processor, cause the integration enabler to:
receive system information of the third-party service system from the third-party service system;
in response to receiving the system information, register and store the system information; and
return a registration result of the system information to the third-party service system.

16. The integration enabler of claim 15, wherein the instructions, when executed by the processor, cause the integration enabler to:
determine whether the third-party services are discontinued or unavailable; and
perform deregistration of third-party services that are discontinued or unavailable among the third-party services.

17. The integration enabler of claim 14, wherein the instructions, when executed by the processor, cause the integration enabler to:
perform protocol adaptation for the service data; and
exchange service data adapted according to the protocol adaptation with the third-party service system.

18. The integration enabler of claim 14, wherein the instructions, when executed by the processor, cause the integration enabler to perform message formatting to ensure structural compatibility and syntactic compatibility for the service data.

19. The integration enabler of claim 14, wherein the defined criteria are determined based on at least one of categories, keywords, and compatibility with the metaverse system for the third-party services.

20. The integration enabler of claim 14, wherein the instructions, when executed by the processor, cause the integration enabler to:
in response to the service discovery request, discover metadata for third-party services comprising service-level properties; and
discover the list of the third-party services based on the metadata.
